(19) United States
(12) Patent Application Publication
(10) Pub. No.: US 2025/0339886 A1
(43) Pub. Date: Nov. 6, 2025

(54) PROCESS FOR EXTRACTION OF COMMON AND PRECIOUS METALS FROM WASTED CIRCUIT BOARDS

(71) Applicant: SENECA EXPERTS-CONSEILS INC., Anjou (CA)

(72) Inventors: Dominique MORIN, Anjou (CA); Raymond SIMONEAU, Anjou (CA); Cristian NEAGOE, Anjou (CA)

(21) Appl. No.: 18/860,864

(22) PCT Filed: May 3, 2023
(86) PCT No.: PCT/CA2023/050602

§ 371 Date: Oct. 28, 2024

Related U.S. Application Data
(60) Provisional application No. 63/364,131, filed on May 4, 2022.

(51) Int. Cl. B09B 3/80; B09B 3/40; B09B 101/17

(52) U.S. Cl. CPC B09B 3/80; B09B 3/40; B09B 2101/17

(57) ABSTRACT

It is provided an environmentally friendly process for recycling metals and nonmetallic components from printed circuit boards (PCBs), without using treatments considered damaging to the environment and minimizing emission of greenhouse gases comprising the steps of shredding the PCBs, micronizing the shredded PCBs producing a micronized powder, removing plastic and epoxy from the micronized powder, leaching, precipitating and recuperating the Al, Fe, Zn, Ni, Cr, Cu, Au, Ag, and Pd from the micronized powder, producing a filtrate from which the Cu is recovered. The solid product of the process is a concentrate of precious metals.

### CROSS-REFERENCE TO RELATED APPLICATION

The present application is claiming priority from U.S. Provisional Application No. 63/364,131 filed May 4, 2022, the content of which is hereby incorporated by reference in its entirety

### TECHNICAL FIELD

It is provided an environmentally friendly process for recycling metals and non-metallic components from printed circuit boards.

### BACKGROUND

The amount of electrical waste (e-waste) is increasing each year by about 2 Mt/year in the world. Just in 2019 approximately 53.6 Mt of electronic waste was generated worldwide and it is estimated that in 2030 this amount will exceed 75 Mt.

The global amount of e-waste in 2019 was 53.6 Mt, of which only 17.4% was recovered. The numbers are estimated to double in 2050. The electronics industry consumes 7% of global Au production, or $63 billion/y. Canada produces 741 kt of electronic waste each year. The e-waste contains many valuable resources and at the same time it is a source of hazardous pollution. The printed circuit board represents about 3% of the e-waste weight and contains common and precious metals, plastics, glass fiber, ceramics, and epoxy resins.

Printed circuit boards (PCBs) generally comprise an insulating board made of epoxy resin and glass fiber, a thin layer of copper foil, covered by a colored solder mask layer, which insulates the copper traces. The conductive pathways of circuits are made of copper. PCBs need to be properly managed when they reach the end-of-life.

Precious metals extracted from obsolete electronics represent a significant source of income but the complexity of the material composition make the recovery difficult.

The traditional methods employed to recover precious metals from printed circuit boards are based on the incineration prior to metal extraction by pyrometallurgy or hydrometallurgy. Those practices drive to the production of toxic and pollutant furans, dioxins and halogenated compounds. Most of this waste is treated in undeveloped countries. The pyrometallurgy produces a huge amount of greenhouse gas. Also, toxic chemicals such as dioxin, furans and brominated and chlorinated compounds are released during the pyro-metallurgical treatment. During the process are released in the air volatilized metals such as Pb, Ga, Sb and As.

Hydrometallurgical methods have been described to selectively extract metals from electronic waste by aqueous solutions. The principle is based on varying solubility of tin lead and copper in different acid or base concentrations.

The electronic components can be detached from the printed circuit board (PCB) by dissolving the solder using an acid or an acid and an oxidizing agent. The hydrometallurgy assisted by ultrasound have been proposed to recover the common and precious metals.

U.S. Pat. No. 8,551,212 describes a system and process to separate precious metal and base metal from e-waste using muriatic acid and oxidants to dissolve the solder and recover gold flake. After a crushing step, a mixture of muriatic acid and hydrogen peroxide dissolve the copper contained in bared boards. The electronic components are micronized separately and exposed to an acid/oxidant solution mixture to dissolve metals. The metals are then recovered in an electrolytic bath or by precipitation.

U.S. Pat. No. 9,731,368 proposes an apparatus and method for stripping solder metals and remove the electronic components from PCB by mechanical and/or thermal process. A combination of acid and oxidant dissolve the metals form solder.

The common and precious metals can also be dissolved from grinded material with a mix of acid, oxidant and iodine in a single leaching step (see U.S. 20170079146).

There is thus still a need to be provided with a means to extract base metal and non-metallic components from printed circuit boards, without using treatments considered damaging to the environment.

### SUMMARY

It is provided a process for recycling metals and non-metallic components from printed circuit boards (PCBs) comprising solder metals and a least one copper layer, wherein the process comprises the steps of shredding the PCBs; micronizing the shredded PCBs producing a micronized powder; removing plastic and epoxy from the micronized powder; leaching, precipitating and recuperating the Al, Fe, Zn, Ni, Cr, Au, Ag, Pd from the micronized powder; and leaching the delaminated content comprising Cu producing a filtrate from which the Cu is precipitate.

In another embodiment, the PCBs are shredded to particles sizes between 5 to 50 mm.

In an embodiment, the micronized powder is washed with caustic soda or a solvent removing epoxy from the shredded PCBs and exposing the solder metals and the at least one copper layer of the shredded PCBs; and the exposed shredded PCBs is treating in a solder leaching reactor dissolving the solder metals producing a solid phase and a leachate containing the solder metals which are recuperated.

In an embodiment, the caustic soda is caustic soda of 1-10M NaOH, or the solvent is KOH or ammonium hydroxides.

In a further embodiment, the solder metals are dissolved in a sulfonic acid solution under the effect of an oxidant in the solder leaching reactor.

In another embodiment, the sulfonic acid is methane sulfonic acid (MSA).

In an embodiment, the oxidant is hydrogen peroxide, pure oxygen, enriched air, air, ozone, nitric acid, oxone, ammonium chlorite, ammonium chlorate, ammonium iodate, sodium hypochlorite, potassium hypochlorite, ammonium hypochlorite, sodium perchlorate, potassium perchlorate or ammonium perchlorate.

In a further embodiment, the solder metals recuperated are Sn, Pb, Al, Ag, Cu, Fe or a combination thereof.

In an embodiment, the process described herein further comprises the step of recuperating ferromagnetic material containing Fe, Ni and Co by magnetic separation of the micronized powder.

In an embodiment, the solid phase is micronized to a powder of less than 2 mm.

In an embodiment, the micronized powder is delaminated at a temperature of about 90 to 150° C. using a hot solvent.

In another embodiment, the hot solvent is DMSO, DMF or a combination of ethylene glycol, solvent NMP and a catalyst.

In a further embodiment, the process encompassed herein further comprises the step of regenerated the hot solvent from the liquid phase by vacuum evaporation.

In another embodiment, the delaminated content is treated with H₂SO₄ at a temperature of about 50 to 75° C.

In an embodiment, the micronized powder is thermal oxidized to remove plastic and epoxy in a heated reactor at temperatures 400 to 950° C. using an oxidizing agent, producing a gas phase.

In an additional embodiment, the oxidizing agent is O₂, air, or enriched air containing between 21-100% O₂.

In another embodiment, the shredded PCBs are treated in a reactor.

In an embodiment, the process described herein further comprises the step of dissolving the epoxy washed from the shredded PCBs to regenerate the caustic soda or the solvent.

In an embodiment, the precipitated and recuperated Al, Fe, Zn, Ni, Cr, Cu, Au, Ag, Pd and inert from the micronized powder is treated with H₂SO₄ producing a liquid phase comprising solubilized Al, Zn, Fe, Ni, Cr, and traces of other common metals and a solid phase comprising Cu, traces of common metals, Au, Ag, Pd and inert.

In another embodiment, Al, Zn, Fe, Ni, Cr and other traces of common metals from the liquid phase are precipitated in a selective precipitation reactor.

In a further embodiment, the Cu and the remaining common metals are leached in a second leach reactor.

In a further embodiment, Cu is leached using H₂SO₄ and a second oxidant.

In another embodiment, the second oxidant is hydrogen peroxide, pure oxygen, enriched air, air, ozone, nitric acid, oxone, ammonium chlorite, ammonium chlorate, ammonium iodate, sodium hypochlorite, potassium hypochlorite, ammonium hypochlorite, sodium perchlorate, potassium perchlorate or ammonium perchlorate.

In an embodiment, the precipitated and recuperated Al, Fe, Zn, Ni, Cr, Cu, Au, Ag, Pd and inert from the micronized powder is treated with H₂SO₄ producing a liquid phase comprising solubilized Al, Fe, Zn, Ni, Cr and traces of other common metals and a solid phase comprising Cu, traces of common metals, Au, Ag, Pd and inert.

In another embodiment, Al, Fe, Zn, Ni, Cr, and other traces of common metals from the liquid phase are precipitated in a selective precipitation reactor.

In a further embodiment, the precipitated and recuperated Al, Fe, Zn, Ni, Cr, Cu, Au, Ag, Pd and inert from the micronized powder is treated with H₂SO₄ and an oxidant in a single reaction step producing a liquid phase comprising solubilized Al, Fe, Zn, Ni, Cr, Cu and a solid phase comprising Au, Ag, Pd and inert.

In a further embodiment, Cu is precipitated in a fully mixed reactor.

In another embodiment, Cu is precipitated with acetone, methanol, or a combination thereof.

In another embodiment, Cu is recovered by cementation or electrowinning.

In an embodiment, the process described herein further comprises recovering residual metals after precipitating Cu by electrodeposition.

In an embodiment, the process described herein further comprises recovering residual metals after precipitating Cu by cementation.

In a further embodiment, the residual metals are Au, Ag and Pd.

In another embodiment, the recovered residual metals are further extracted using sodium hypochlorite.

In an embodiment, the recovered residual metals are extracted using an environmentally friendly process, ex. CLEVR Process™.

In another embodiment, the PCBs are single-layered, double-layered or multilayered.

### BRIEF DESCRIPTION OF THE DRAWINGS

Reference will now be made to the accompanying drawings.

FIG. 1 illustrates the general process flow diagram of the PCB recycling in accordance to an embodiment.

FIG. 2 illustrates the general process flow diagram of PCB recycling with a thermal oxidation step in accordance to another embodiment.

FIG. 3 illustrates the results of the thermal treatment of printed circuit boards.

It will be noted that throughout the appended drawings, like features are identified by like reference numerals.

### DETAILED DESCRIPTION

It is provided an environmentally friendly process for recycling metals and non-metallic components from printed circuit boards. The process described herein comprises mechanical and hydrometallurgical steps to selectively extract base metal and non-metallic components from printed circuit boards (PCBs), without using treatments considered damaging to the environment, like aqua regia, cyanide based method or pyro-metallurgical treatments. The emission of greenhouse gases is minimized, and no toxic compounds are released.

PCBs are made up of successive layers of different materials. In a simplified manner, PCBs are formed of three main layers having the structure of a sandwich:
1. the substrate is formed by a layer of several fibreglass fabric;
2. one or more thin sheets of copper;
3. the tie layer, which can be composed of a layer of epoxy resin enriched with a substance based on bromine (Br), to retard the flame (ex. PBDE, TBBPA, HBCD, PBB); and
4. a layer of epoxy (mask) which is deposited on the surface of the plates to protect the contacts and sometimes the electronic components.

Depending on the number of copper (Cu) layers, PCBs can be single-layered, double-layered or multilayered.

The PCB is the support for the electronic elements (resistors, capacitors, diodes, integrated circuits, etc.). It is thus provided a process to recycle PCBs with soldered electronic components. As encompassed, the composition and the structure of the PCB varies depending on the electronic device.

Precious metals (PM) are found in microprocessors and in electrical contacts. The contactors are covered with thin films of Ag and Sn on the Cu fins to prevent oxidation. Ag is also found in surface capacitors. Pb, Bi, Sn, Ag are found in the welds.

As encompassed herein, the process described herein provides an environmentally friendly means to extract epoxy, brominated compounds and common metals such as Cu, Pb, Sn, Al, Fe, Co, Zn. At the end of the process, the material is prepared for the recovery of Al, Fe, Zn, Ni, Cr, Cu, Au, Ag, Pd. The process includes coarse shredding, mask removal, solder leaching, micronization, delamination, acid leaching, oxidative leaching, precipitation and electrolytic recovery of metals.

In an embodiment, the method provided allows for extraction of epoxy and remove the brominated compounds without incineration. Thermogravimetric studies showed that the brominated compounds (TBBPA) will not decompose before 150° C. and they remain attached to the extracted epoxy resin.

The term “Printed Circuit Board” or “PCB” is intended to mean an electronic circuit consisting of thin strips of conducting material such as copper, which have been etched from a layer fixed to a flat insulating sheet called a printed circuit board, and to which integrated circuits, electronics and other components are attached.

The term “shredding” is intended to mean a process of breaking into particulate of sizes 5-50 mm in a e.g., but not limited to a, 2 axis shredding machine.

The term “micronization” is intended to mean a process to reduce the average diameter of a solid under the scale of the millimeter.

The term “leaching” is intended to mean a chemical process to dissolve in a solution some solid component using a solvent or a mixture of solvents.

The term “flotation” is intended to mean a process for selectively separating components, usually solids, using difference in density between the components and a fluid, usually water.

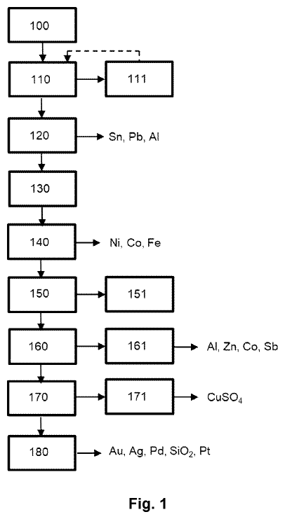

As seen in FIG. 1, the process comprises a first step 100 of crushing (shredding) the printed circuit boards (PCB), such as in a shredder for example, to generate 5-50 mm pieces.

PCBs are covered over the entire surface with a layer of epoxy (mask) which protects the copper circuitry. On this layer is printed information about the electronics. In order to make the copper layer available, this layer must be leached. During the second step 110, the mask is treated (i.e. caustic washing) with caustic soda, 1-10M NaOH in or KOH or ammonium hydroxides, in order to remove the epoxy. The reaction temperature is chosen (e.g. 50-120° C.).

The reaction is carried out in a fully mixed heated reactor. The dissolved epoxy is separated from the caustic liquid phase into a decanter (step 111), allowing regeneration of the solvent and the solution can be reused in the leaching step 110. The solids are treated in a solder leaching reactor (step 120). The typical alloy composition is 63% Sn/37% Pb. A proposed solvent for this operation is a sulfonic acid which dissolves Sn and Pb under the effect of an oxidant. The acid may be for example any sulfonic acid but the preferred one is the methane sulfonic acid (MSA). The oxidizing mediator includes, but are not limited to, hydrogen peroxide, pure oxygen, air, ozone, nitric acid, oxone, ammonium chlorite or chlorate or iodate, sodium, or potassium or ammonium hypochlorite and perchlorate, sodium or potassium or ammonium. Sn, Pb and/or Al are recuperated at this stage. Silver, as well as some copper and iron can also be found in the MSA solution.

After liquid-solid separation and washing the solid phase is micronized 130 into ≤2 mm powder. The ferromagnetic material containing Fe, Ni and Co can be separated by magnetic separation 140.

The micronized composite is afterwards delaminated 150 using a hot solvent such as e.g. DMSO, DMF or a combination of ethylene glycol, solvent (NMP) and catalyst (TBD). The result of this reaction is the complete opening of the composite and the exposure of the metals. The reactor is completely mixed and heated to 90-150° C. After 90 minutes, the epoxy resin will be in the liquid phase and the glass fibres will be completely delaminated. Metals are not soluble in upper named solvents. The solvent is regenerated in the step 151 by vacuum evaporation.

After delamination, the contents of the reactor will be filtered and washed. In the step 160 the micronized and delaminated PCB is treated with H₂SO₄ in a complete stirred reactor. During this phase the majority of Al and the remains of Zn, Sn will be solubilized at 50-75° C.

After the reaction, the contents of the reactor are decanted and filtered. The liquid phase is sent to the selective precipitation reactor 161. The Al and the other metals (e.g. Zn, Co, Sb) are selectively precipitated with NaOH or Ca(OH)₂.

The solids from the step 160 are conveyed to a second leach reactor 170 where the leaching is carried out using H₂SO₄, at 50-75° C., and an oxidant. The oxidizing mediator includes, but are not limited to, hydrogen peroxide, pure oxygen, air, enriched air, ozone, nitric acid, oxone, ammonium chlorite or chlorate or iodate, sodium, or potassium or ammonium hypochlorite and perchlorate, sodium or potassium or ammonium. After this leaching step, 95% of Cu and 95% of the other common metals are removed from the micronized PCB. The filtrate from the Cu leach reactor is precipitated 171 with acetone or methanol in a fully mixed reactor. The method is called SDC (Solvent Displacement Crystallization) and involves reducing the solubility of an inorganic solute with an organic solvent. Polar solvent molecules have a higher affinity for water molecules than metal ions. Bonds formed with water molecules result in decreased solubility of metals and hence precipitation. The presence of the organic solvent in the aqueous H₂SO₄/H₂O solution decreases the dielectric constant by replacing the hydrogen bonds between the water molecules with alcohol-water type bonds. The solvent precipitation of copper may be replaced also by a cementation on metallic iron. The rest of the metals are recovered by electrodeposition or precipitation with NaOH or KOH or CA(OH)₂ 180.

After the reaction, the contents of the reactor are decanted and filtered. The solid phase, purified of the common metals and epoxy, is used to recover the Au, Ag and Pd.

In an alternate embodiment, the process described herein comprises a step of thermal oxidation to remove all plastic matter and epoxy found in the PCB. The term “thermal oxidation” is intended to mean the reaction with oxygen at a temperature between 400° C. and 950° C. This treatment replaces the epoxy removal with organic solvents. The thermal oxidation is followed by a total oxidation step where all hydrocarbons in the gas phase are oxidized to carbon dioxide and water. The water produced is then condensed, and heat is recovered in a heat exchanger. An alkaline scrubber is fixing a fraction of carbon dioxide as sodium carbonate and bicarbonate. The fluorine, chlorine and bromine are present in the liquid phase as molecular halogens and hydro halide acid. In an embodiment the fluorine is recovered as CaF₂ by reaction with CaO.

After removal of the organic components of the thermal oxidation exhaust gas, the halide acids are dissolved and a fraction of CO₂ is fixed as bicarbonate in an alkaline scrubber 152. A “scrubber” is known to mean any equipment designed to wash a gas stream with an alkaline solution to remove or trap certain components.

The alkaline agent may be NaOH, CaOH or KOH at concentration from 1 to 10M. The residual CO₂ is released to the atmosphere and the precipitate formed during the reaction is removed by filtration. The NaCl and NaBr are recycled to the precious metals extraction.

The fluoride is removed as CaF₂ by mixing CaO or Ca(OH)₂ 153 with the liquor issued from the scrubber.

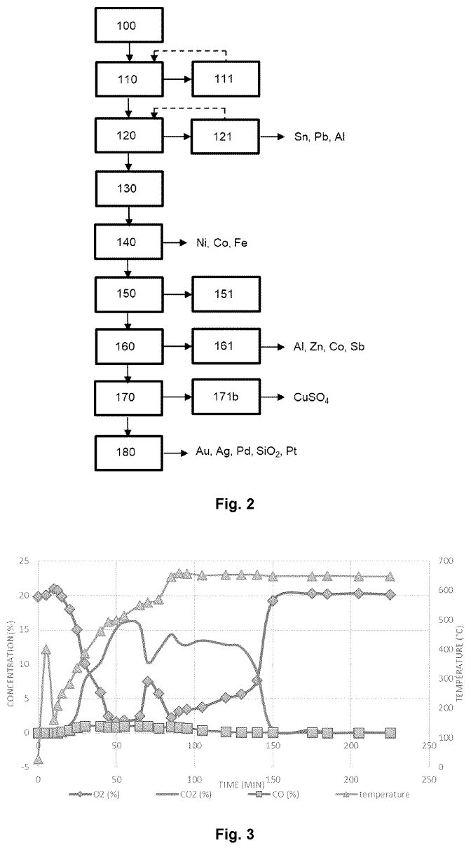

In an embodiment the thermal removal of the plastic can be followed or preceded by an acid leaching step (e.g. see 171b in FIG. 2) of Cu and of the others common metals (Fe, Al, Zn, Co, Ni, etc.).

In an embodiment, the precious metals are recovered from the micronized, delaminated and common metal-free WPCB in a further process using, e.g., but not limited to, the CLEVR Process™ which has the advantage of operating in a closed loop and all chemicals are recycled within the circuit and, sea water is also suitable where available.

Depending on the nature of the raw material, pre-treatment may be required prior to the extraction step.

If the oxidized mineral contains base metals that need to be recovered, such as copper, a water or acid leach is carried out prior to the extraction step. In fact, if the operation conditions of the controlled oxidation predominately lead to the formation of copper sulphates, a water leach, instead of an acid leach with sulfuric acid, can be performed. Following the filtration of the water or acid leached slurry, copper can recuperated.

### EXAMPLES

### Extraction of Solder Metal

Small-scale experiments with 100 g of 25 mm shredded printed circuit boards were performed using as solvent a 3.5M methane sulfonic acid with 0.5 M hydrogen peroxide for 120 minutes. The extraction of the solder was realized at ambient temperature and with a ratio liquid/solid of 1/10 kg/l.

The results are presented in the Table 1.

TABLE 1
The removal efficiency of the solder metals

| | Experiment |
|---|---|
| Efficiency of extraction | # 1 |
| Au | 0% |
| Ag | 0% |
| Pb | 92% |
| Sn | 92% |
| Cu | 24% |

After the leaching step, the solids were separated and washed with 200 ml distilled water. The metals in the leachate and in the water were analyzed by inductively coupled plasma (ICP).

To evaluate the metals still available on the printed circuit board pieces, after the treatment, the solids were treated with aqua regia for four hours at 90° C. All available metals were dissolved. It was assumed that the sum of metals on methane sulfonic leachate, washing water and aqua regia leachate represents the total of available metals on the pieces.

So the results of the Table 1 regard only the available metals that are not covered by epoxy and not imprisoned in the electronic components. The majority of copper is protected by the epoxy mask so not available for leaching. For example, in the table 1, only 24% of available copper was leached by the acid solution.

### Example II

### Removal of the Mask

The solder mask, solder stop mask or solder resist is a thin layer of a polymer that is usually applied to the surface of printed circuit boards, over the copper as protection against the oxidation and to prevent short circuits.

Printed circuit board issued from video cards and mother boards feed were shredded to 5 mm chips and treated with methane sulfonic acid to remove the solder as in the Example I. The electronic components and the printed circuit chips were treated with 10% NaOH solution at 90° C. for 105 min. After the reaction, the coper layer was completely exposed and available for recovery. The Table 2 presents the results of the experiment.

TABLE 2
Condition and results of solder mask removal experiment

| Mass of printed | Volume of | | Time of | Mass of solids |
|---|---|---|---|---|
| circuits | 10% NaOH | Temp. | exposure | after treatment |
| 129.8 g | 390 mL | 90° C. | 105 min | 120.8 g |

### Example III

### Removal of Organics by Thermal Treatment

The printed circuit board chips issued from mother boards and video cards were micronized to a size under 1 mm. One hundred and two grams (102 g) of this matter was fed in a horizontal quartz oven heated at a maximum temperature of 650° C. The pure oxygen was fed to the oven at 5-10 LPM flow during the whole experiment. The concentrations of CO, CO₂, and O₂ were followed by a gas analyzer. The results are shown in FIG. 3.

The oxygen reacts rapidly with the organic and its concentration decreases starting with 160° C. At 550° C. all the fed oxygen is consumed into the reaction. After 150 min the level of the CO₂ production decreases at zero and the available organic already reacted.

The total carbon analysis of the mixture treated shows that all plastic and epoxy were removed. The mass loss was of 34.5% that corresponds to the level of all organic on printed circuit boards.

The results are presented in the Table 3.

TABLE 3
Results of the thermal oxidation

| Printed circuits | Printed circuits | Removed | Total organic carbon |
|---|---|---|---|
| mix inlet | mix outlet | organic | on treated mix |
| 102.0 g | 66.8 g | 34.5% | 0.66 0.005% C |

### Example IV

### Removal of Basic Metals

The printed circuit boards previously shredded, leached by methane sulfonic acid and micronized to <1 mm particle size, was treated by sulphuric acid solution and by sulphuric acid and peroxide.

A mass of 780 g of material, treated as described, was mixed with 7.8 L of H₂SO₄ 1 M for 4 h at 50° C. After this first treatment, the sludge was filtrated and the solids were used for a second leaching treatment using 1.2 M H₂SO₄ and H₂O₂ for 3.5 h at 72° C. After filtration metallic copper was still visible in the solids and a third leaching was performed with 2 M H₂SO₄ and H₂O₂ for another 4 h. The temperature was stabilized at 75° C. In all the experiments, the ratio liquid/solid was 10 l/kg.

The results of the common metal removal experiments are presented in the Table 4.

TABLE 4
Results of common metal removal experiments

| | | | Efficiency of metal removal from solids (%) | | | | | | |
|---|---|---|---|---|---|---|---|---|---|
| Treatment | HH₂SO₄ | HH₂O₂ | Cu | Al | Fe | Zn | Ni | Co | Cr |
| 1 | 1M | 0 | 33.0 | 17.1 | 36.1 | 0.2 | 35.8 | 28.5 | 37.0 |
| 2 | 1.2M | 800 g | 43.6 | 22.8 | 47.0 | 94.0 | 46.9 | 40.0 | 48.7 |
| 3 | 2M | 400 g | 23.4 | 40 | 13.3 | 5.1 | 17.3 | 11.4 | 8.7 |

While the present disclosure has been described with particular reference to the illustrated embodiment, it will be understood that numerous modifications thereto will appear to those skilled in the art. Further, the present disclosure has been described in connection with specific embodiments thereof, it will be understood that it is capable of further modifications and this application is intended to cover any variations, uses, or adaptations and including such departures from the present disclosure as come within known or customary practice within the art and as may be applied to the essential features hereinbefore set forth, and as follows in the scope of the appended claims.

What is claimed is:

1. A process for recycling metals and non-metallic components from printed circuit boards (PCBs) comprising solder metals and a least one copper layer, wherein the process comprises the steps of:
a) shredding the PCBs;
b) micronizing the shredded PCBs producing a micronized powder;
c) removing plastic and epoxy from the micronized powder;
d) leaching, precipitating and recuperating the Al, Fe, Zn, Ni, Cr, Au, Ag, Pd from the micronized powder producing a delaminated content; and
e) leaching the delaminated content comprising Cu producing a filtrate from which the Cu is precipitated.

2. The process of claim 1, wherein the PCBs are shredded to particles sizes between 5 to 50 mm.

3. The process of claim 1 or 2, wherein the micronized powder is washed with caustic soda or a solvent removing epoxy from the shredded PCBs and exposing the solder metals and the at least one copper layer of the shredded PCBs; and the exposed shredded PCBs is treating in a solder leaching reactor dissolving the solder metals producing a solid phase and a leachate containing the solder metals which are recuperated.

4. The process of claim 3, wherein the caustic soda is caustic soda of 1-10M NaOH, or the solvent is KOH or ammonium hydroxides.

5. The process of claim 3 or 4, wherein the solder metals are dissolved in a sulfonic acid solution under the effect of an oxidant in the solder leaching reactor.

6. The process of claim 5, wherein the sulfonic acid is methane sulfonic acid (MSA).

7. The process of claim 5 or 6, wherein the oxidant is hydrogen peroxide, pure oxygen, enriched air, air, ozone, nitric acid, oxone, ammonium chlorite, ammonium chlorate, ammonium iodate, sodium hypochlorite, potassium hypochlorite, ammonium hypochlorite, sodium perchlorate, potassium perchlorate or ammonium perchlorate.

8. The process of any one of claims 3-7, wherein the solder metals recuperated are Sn, Pb, Al, Ag, Cu, Fe or a combination thereof.

9. The process of claim 3, wherein the solid phase is micronized to a powder of less than 2 mm.

10. The process of any one of claims 1-9, further comprising the step of recuperating ferromagnetic material containing Fe, Ni and Co by magnetic separation of the micronized powder.

11. The process of any one of claims 1-10, wherein the micronized powder is delaminated at a temperature of about 90 to 150° C. using a hot solvent.

12. The process of claim 11, wherein the hot solvent is DMSO, DMF or a combination of ethylene glycol, solvent NMP and a catalyst.

13. The process of claim 11 or 12, further comprising the step of regenerated the hot solvent from the liquid phase by vacuum evaporation.

14. The process of any one of claims 11-13, wherein the delaminated content is treated with H₂SO₄ at a temperature of about 50 to 75° C.

15. The process of any one of claims 1-10, wherein the micronized powder is thermal oxidized to remove plastic and epoxy in a heated reactor at temperatures 400 to 950° C. using an oxidizing agent, producing a gas phase.

16. The process of claim 15, wherein the oxidizing agent is O₂, air, or enriched air containing between 21-100% O₂.

17. The process of claim 15 or 16, wherein the gas phase produced is oxidized in a catalytic reactor or incinerator to convert all the organic components to CO₂ and H₂O resulting in an exhaust gas.

18. The process of claim 3, further comprising the step of dissolving the epoxy washed from the shredded PCBs to regenerate the caustic soda or the solvent.

19. The process any one of claim 18, wherein the shredded PCBs are treated at a temperature of about 50 to 120° C.

20. The process of claim 18 and 19, wherein the shredded PCBs are treated in a reactor

21. The process of any one of claims 1-20, wherein the precipitated and recuperated Al, Fe, Zn, Ni, Cr, Cu, Au, Ag, Pd and inert from the micronized powder is treated with H₂SO₄ producing a liquid phase comprising solubilized Al, Fe, Zn, Ni, Cr and traces of other common metals and a solid phase comprising Cu, traces of common metals, Au, Ag, Pd and inert.

22. The process of claim 21, wherein Al, Fe, Zn, Ni, Cr, and other traces of common metals from the liquid phase are precipitated in a selective precipitation reactor.

23. The process of any one of claims 1-22, wherein the Cu and the remaining common metals are leached in a second leach reactor.

24. The process of claim 23, wherein Cu is leached using H₂SO₄ and a second oxidant.

25. The process of claim 24, wherein the second oxidant is hydrogen peroxide, pure oxygen, air, enriched air, ozone, nitric acid, oxone, ammonium chlorite, ammonium chlorate, ammonium iodate, sodium hypochlorite, potassium hypochlorite, ammonium hypochlorite, sodium perchlorate, potassium perchlorate or ammonium perchlorate.

26. The process of any one of claims 21 and 23-25, wherein Cu is leached at 50 to 75° C.

27. The process of any one of claims 21 and 23-26, wherein the precipitated and recuperated Al, Fe, Zn, Ni, Cr, Cu, Au, Ag, Pd and inert from the micronized powder is treated with H₂SO₄ and an oxidant in a single reaction step producing a liquid phase comprising solubilized Al, Fe, Zn, Ni, Cr, Cu and a solid phase comprising Au, Ag, Pd and inert.

28. The process of any one of claims 1-27, wherein Cu is precipitated in a fully mixed reactor.

29. The process of any one of claims 1-27, wherein Cu is precipitated with acetone, methanol, or a combination thereof.

30. The process of any one of claims 1-27, wherein Cu is recovered by cementation or electrowinning.

31. The process of any one of claims 1-30, further comprising recovering residual metals after precipitating Cu by electrodeposition.

32. The process of claim 1-31, wherein the residual metals are Au, Ag and Pd.

33. The process of claim 32, wherein the recovered residual metals are further extracted using sodium hypochlorite.

34. The process of claim 32, wherein the recovered residual metals are extracted using the CLEVR Process™.

35. The process of any one of claims 1-34, wherein the PCBs are single-layered, double-layered or multilayered.
